(19) United States
(12) Patent Application Publication
(10) Pub. No.: US 2026/0273913 A1
(43) Pub. Date: Sep. 17, 2026

(54) Laminated timber beam production system

(71) Applicant: MINDA Industrieanlagen GmbH, Minden (DE)

(72) Inventor: Hubertus ZEDDIES, Hannover (DE)

(21) Appl. No.: 19/460,907

(22) Filed: Jan. 27, 2026

(30) Foreign Application Priority Data
Jan. 31, 2025 (DE) 10 2025 103 709.4

(51) Int. Cl. B32B 38/18; B32B 21/04; B32B 37/12; B32B 37/18; B32B 38/00; B65G 13/02; B65G 13/12; E04C 3/12

(52) U.S. Cl. CPC B32B 38/1808; B32B 21/042; B32B 37/12; B32B 37/18; B32B 38/1875; B65G 13/02; B65G 13/12; E04C 3/122; B65G 2201/0282

(57) ABSTRACT

A laminated timber beam production system for producing curved laminated timber beams includes a laminated beam intake for receiving one or more timber bundles composed of glued timber slats, and a plurality of clamping slides, each clamping slide of the plurality of clamping slides comprising one or more positioning slides, each of which comprises at least one first pressure shoe which is guidable on a linear guide, and one or more feed slides, each of which comprises at least one second pressure shoe which is guidable on the linear guide. At least one positioning slide of the one or more positioning slides and at least one feed slide of the one or more feed slides are arranged such that by moving the at least one positioning slide and the at least one feed slide towards each other, a predetermined press force is applyable to the timber bundle. Each of the one or more positioning slides is connected or connectable to a positioning drive for positioning the one or more positioning slides in a predeterminable position along the linear guide. Associated with the plurality of the clamping slides is at least one tensile force generator. The tensile force generator is arranged below a contact surface for the timber bundle intake and is configured to automatically generate a tensile force that acts in each case between a positioning slide and a feed slide.

### FIELD OF THE INVENTION

The invention relates to a laminated timber beam production system for producing curved laminated timber beams with (a) a timber bundle intake for receiving a timber bundle of glued timber slats, and (b) a number of clamping slides, each comprising (i) a positioning slide, which comprises at least one pressure shoe and is guided on a linear guide, (ii) a feed slide, which comprises at least one pressure shoe and is guided on the linear guide, and (iii) being arranged in such a way that a predetermined press force can be applied to the timber bundle by moving positioning slide and feed slide towards each other, wherein (c) each positioning slide is connected to a positioning drive for positioning the positioning slide in a predeterminable position along the linear guide.

According to a second aspect, the invention relates to a method for producing a laminated timber beam, particularly using a laminated timber beam production device according to the invention.

### BACKGROUND

Laminated timber beams are components, particularly for use in building construction, which, similar to steel beams, absorb loads and transfer them to load-bearing structures. Laminated timber beams can extend in a straight line or be curved in the longitudinal direction. Laminated timber beams curved in the longitudinal direction, especially those that are more than 30 m in length, have thus far been produced in so-called manual press beds.

Laminated timber beams are made up of timber slats which are, for example, 20 to 40 mm thick and/or 80 to 300 mm wide. The length of the timber slats is at least the length of the laminated timber beams to be produced. The timber slats are often composed of at least two partial slats that are joined together, for example by way of finger-joint connections. The timber slats are glued, bonded together to form a timber bundle and then introduced into a press, for example by an indoor crane.

Due to the large forces required to tension and bend the timber bundle, frames are used, like those described in DE 10 20130 001 100 B4, for example, which enable a circular closed force flow around the timber bundle.

When producing laminated timber beams, it is preferable to be able to produce the longest possible laminated timber beams which also exhibit the fewest possible restrictions with regards to curvature. It is also preferable to minimise production time for laminated timber beams, reduce personnel requirements and avoid heavy physical labour.

DE 10 2006 013 327 B3 discloses a system for producing laminated beams with at least one folding laminated beam press with a press frame and a folding frame. The laminated beam press uses punches to produce a laminated beam from a timber slat bundle of glued timber slats when a press force is applied. A horizontally movable portal carriage with vertically movable lifting arms is arranged above the laminated beam press, which places the glued laminated timber bundle into the open laminated beam press and removes the laminated beam after pressing, wherein the lifting arms and the press frame are inclined at an angle to the vertical.

DE 101 06 560 A1 describes a glueing press with a hold-down clamp between each pair of pressure beams, which are inclined from a vertical position towards the pressure beams and can be swivelled away from them. For applying the glued material, each of the pressure beams is inclined between a press plate on a press cylinder and a counter press plate. The hold-down clamp is inclined to press the glued material against the pressure beams and can be locked in a closing mechanism that is connected to a frame of the gluing press. To ensure that a large safety area is not required in front of the glueing press and that a high press force can be exerted on the material being pressed, the hold-down clamp is, on the one hand, guided largely vertically and can be raised into a vertical release position that frees the pressure beams, whereby a lower end section of the hold-down clamps is unlocked from the closing mechanism. On the other hand, it can be lowered out of the release position into the working position, in which the lower end section of the hold-down clamp is locked in the closing mechanism.

DE 10 2013 001 100 B4 discloses a device for producing laminated timber beams with multiple frame elements spaced apart from one another, each of which comprises a punch with a press plate and a counter press plate, between which a glued timber bundle can be inserted and pressed to form a laminated timber beam when a press force is applied, and with a transport device for inserting the timber bundle and transporting the pressed laminated timber beams, and with devices for adjusting a camber of the press plates or counter press plates. Multiple counter press plates are mounted in the respective frame element such that they can be displaced in the press direction and the counter press plates are braced on the frame elements by spacers.

AT 400 691 B describes a production system for producing a blank profile composed of bar or board-like slats made of timber, plastic etc. with a press device arranged in a press area of the bar or board-like slats, said press device comprising multiple tension devices spaced apart from each other with clamping jaws and clamping actuators assigned to them. In said press device, the clamping actuators for the clamping frames and the clamping frames themselves are arranged spatially apart from each other and can be moved relatively towards each other. A transport device (105) is assigned to the clamping frames, wherein the former extends at least from the press area to an intermediate storage location (106) and is designed to receive a number of the clamping frames that form the press device. During the pressing process, the clamping frames remain in an intermediate storage position with the pre-tensioned blank profile.

### SUMMARY

The invention is based on the task of improving the production of laminated timber beams, especially curved and long laminated timber beams.

The invention solves the problem by way of a laminated timber beam production system in which the clamping slides comprise a tensile force generator which (i) is configured to automatically generate a tensile force that acts between a positioning slide and a feed slide. The tensile force generator (ii) is preferably arranged, particularly completely, below a support surface of the timber bundle intake. The invention also solves the problem by way of a method for producing a laminated timber beam by means of a laminated timber beam production system according to the invention, comprising the steps (a) activating a transfer conveyor and/or a timber bundle feed such that a timber bundle is positioned between the first press shoes and the second press shows of the clamping slides, (b) activating the positioning drive so that the positioning slides drive to a predetermined position, (c) activating the aligners such that the timber bundle is aligned along a horizontal plane, (d) activating the tensile force generator such that the positioning slides and the feed slides exert the predetermined press force on the timber bundle, resulting in the laminated timber beam, and (e) activating the roller bed such that the produced laminated timber beam is transported out of the laminated timber beam press.

An advantage of the invention is that it also enables the production of longer laminated beams, for example with a length of more than 30 m, in an automated manner. Since the tensile force generator is arranged below the support surface of the timber bundle intake, the clamping slide can be open at the top. It is then possible to insert the timber bundle automatically into the clamping slide from above, to move the clamping slide automatically into a predetermined position and to automatically apply the press force.

Since the specified steps can be carried out automatically, a glue can be used that cures in less than 40 minutes (curing time), especially within a maximum of 30 minutes, as is intended in one preferred embodiment. This enables a significant reduction in the time required to produce a laminated timber beam. Of course, a slower glue with a curing time of 1 to 1.5 hours, for example, could also be used.

Since the press force is generated by means of a tensile force generator, the first press shoe and the second press shoe can be spaced relatively far apart from each other without the application of the press force causing a buckling load on the tensile force generator.

Within the scope of the present description, the timber bundle intake refers to a structure onto which the timber bundle can be placed in such a way that it can then be pressed by means of the clamping slides.

The pressure shoe refers to a structure that is designed to exert the press force on the timber bundle.

The characteristic that the positioning slide can be positioned to a predeterminable position along the linear guide is understood to mean that the positioning slides can be positioned, particularly automatically, in such a way that the laminated timber beam has a predeterminable and/or predetermined contour after pressing. The contour of the laminated timber beam refers to the contour of a lateral surface of the finished laminated timber beam, particularly the contour of the lateral surface that faces downwards when the laminated timber beam is used as intended. The contour preferably extends along a predeterminable curved and even curve.

A tensile force generator refers to a device whose active component comprises two parts that move towards each other or decrease in length when the tensile force is generated. The active component of the tensile force generator is the component that converts supplied energy, such as pressure energy from a supplied hydraulic fluid, into the tensile force.

The characteristic that the tensile force generator is arranged below the support surface of the timber bundle intake is understood particularly to mean that an active component of the tensile force generator is arranged below the timber bundle intake. In particular, the tensile force generator is arranged in such a way that a circular closed force flow is not created upon application of the tensile force.

When the positioning slide and the feed slide are in contact with the timber bundle, the tensile force corresponds to the press force. In each case, one positioning slide and one feed slide are connected to each other by means of the tensile force generator. Preferably, one positioning slide and one delivery slide can be jointly positioned by means of the positioning drive.

The clamping slides are preferably designed in such a way that a press force can be applied that corresponds to a pressing pressure of at least 1 megapascal and/or at most 3 megapascal.

According to one embodiment, the clamping slides are configured to position the timber bundle between the respective positioning slide and the respective feed slide by way of a movement of the timber bundle from above. In other words, the clamping slides are open at the top.

The timber bundle intake and the clamping slides are designed to receive a timber bundle that is lying down. The characteristic of a timber bundle lying down is understood to mean that the timber slats are lying on their narrow side.

Preferably, the clamping sides each have at least one guide part by means of which the clamping slide is movably attached to the linear guide. The guide part may comprise, for example, at least one, but in particular two, pairs of rollers.

It is beneficial if the tensile force generator is a hydraulic cylinder. For example, the hydraulic cylinder is configured to generate a tensile force of at least 240 kN. A small laminated timber beam press for narrow laminated beams could also be realised with a significantly smaller tensile force.

The linear guide is preferably designed to absorb a tilting torque that develops due to the tensile force on the guide part. Since the tensile force generator is arranged below the contact surface of the timber bundle intake, particularly because the clamping force is not applied by a circular closed force flow around the timber bundle, a tilting torque develops, which has to be absorbed by the guide. Although this requires more complex guides than in laminated timber beam production systems according to the prior art, it has been proven that the advantages, especially the insertion of the timber bundle into the clamping slides from above, outweigh this disadvantage.

According to one embodiment, the laminated timber beam production system is configured to produce curved laminated timber beams.

Preferably, the clamping slides are arranged in relation to the timber bundle intake in such a way that the timber bundle can be tensioned along a curve, wherein the curve extends exclusively in the plane along which the timber bundle intake extends. For example, if the plane extends horizontally, as intended in one preferred embodiment, the curve extends in this horizontal plane.

According to one embodiment, the feed slides are designed in such a way that the press force at least largely acts along a plane along which the timber bundle extends when it is lying on the timber bundle intake.

The clamping slides are preferably configured to jointly clamp a timber bundle, especially precisely one timber bundle.

According to one embodiment, the laminated timber beam production system comprises a plurality of aligners, each of which has (a) a pressure beam and (b) a pressure beam drive by means of which the pressure beam can be pressed onto the timber bundle from above.

According to one embodiment, the laminated timber beam production system comprises a plurality of aligners, at least the majority, but preferably all, of which are attached to one clamping slide each. Each aligner can be brought into a clamping position and a neutral position. In the clamping position, the aligner, especially a pressure beam of the aligner, exerts a force, in particular from above, on the timber bundle such that the timber slats are aligned.

The timber slats are not perfectly straight and dimensionally stable; they often curved, twisted and cupped. It is therefore advantageous to laterally align the glued timber bundle prior to exerting the press force so that the sides of the timber slats are flush against each other. Since the timber bundle is in the laminated timber beam press, the aligning force is applied from above. The lower side of the timber bundle lies on the flat timber bundle intake. According to one embodiment, the pressure beam is designed to lock with the clamping slides. The locking allows the aligning force to be absorbed in a closed force flow around the timber bundle and so does not have to be absorbed by the swivel drive or the base.

The aligning force required to align is preferably exerted by the pressure beam of the respective aligner. The pressure beam is connected to a pressure beam drive, particularly in the form of at least one hydraulic cylinder, preferably at least two, especially precisely two, cylinders. The two cylinders are preferably pressure cylinders.

The aligner preferably has a synchronisation control unit. In other words, the aligner is preferably configured to move the pressure beam in such a way that the pressure beam extends at least largely parallel to the timber bundle intake on a contact surface where the pressure beam is in contact with the timber bundle. The feature that the contact surface extends at least largely parallel to the timber bundle intake is understood particularly to mean that a deviation from a strict parallelism is at most 0.5°, in particular at most 0.1°. This is preferably ensured by a hydraulically controlled synchronisation of the two cylinders.

According to one embodiment, the positioning drive has a threaded spindle. It is beneficial if the positioning drive, especially the threaded spindle, is self-locking. This is understood to mean that a force on the threaded spindle in the direction of the rotation axis of the threaded spindle does not lead to a rotation of the spindle. This allows especially high forces to be absorbed.

The positioning drive preferably has a positioning control unit, allowing the positioning slide to be driven to a predeterminable position.

According to one embodiment, the laminated timber beam production system has a timber bundle feed that is designed to automatically guide the timber bundle between the at least one first pressure show and the at least one second pressure shoe. In other words, the timber bundle feed is designed to transport the timber bundle from a position that is not between the two pressure shoes to the timber bundle intake between the at least one first pressure shoe and the at least one second pressure shoe.

The height of the timber bundle preferably reduces along the way. In other words, the timber bundle feed supplies the timber bundle from above. Feeding in this manner is particularly simple and is enabled by the fact that the clamping slides are open at the top.

According to one embodiment, the laminated timber beam production system comprises at least one transfer conveyor which can be brought into (a) a transfer position in which, together with a conveyor of the timber bundle feed, it forms a conveyor path for the timber bundle, and (b) a neutral position, in which the timber bundle is arranged for pressing in the clamping slide. Preferably, the transfer conveyor can be swivelled from the transfer position into the neutral position. A swivel movement is a movement that involves rotation. For example, a swivel movement is a purely rotary movement or a combined rotation and translation movement. The conveyor path preferably extends along a plane. In this case, there are few forces acting between adjacent slats of the timber bundle at the point of transfer into the clamping slide.

The transfer conveyor is fixed, for example, to the base between the clamping slides. The timber bundle is straight, i.e. not curved, when inserted. The positioning slides are in a line. At this point, the clamping slides are preferably completely open. As a result, the timber bundle can be easily positioned between the respective positioning slide and the feed slide.

The transfer conveyor and the timber bundle feed are positioned by the control unit in such a way that the timber bundle can be transferred from the timber bundle feed to the transfer conveyor. The control unit can have two or more controller units, which can be spatially separated from each other.

The laminated timber beam production system preferably comprises a timber bundle production device for producing timber bundles from timber slats. The timber bundle production device preferably has a gluer that is configured to glue timber slats, especially on their broad sides. The timber bundle production device preferably has a timber bundle feed.

The timber bundle feed preferably has a chain conveyor, especially one that can move vertically, especially a chain conveyor that can be swivelled up and down. Alternatively, the timber bundle feed, particularly the chain conveyor, is firmly fixed to the base and/or cannot be swivelled. This results in an especially simple structure.

According to one embodiment, the gluer comprises a glue container. The glue container is preferably filled with a glue, in particular a glue with a curing time of at most 30 minutes, particularly at most 20 minutes.

For the purpose of transporting the finished laminated timber beam, the laminated timber beam production system preferably comprises a roller bed, which has a plurality of height-adjustable mounted transport rollers. Preferably, the roller bed has at least one transport roller drive for driving at least part of the transport roller. The roller bed enables the laminated timber beam to be transported out of the laminated timber beam press. The laminated timber beam press comprises the timber bundle intake, the clamping slides, the positioning drives and the tensile force generator. In particular, the roller bed is designed to transport the laminated timber board transversely to a direction of movement of the clamping slides.

It is beneficial if the laminated timber beam production system can be operated automatically. To this end, it preferably comprises a control unit, which is configured to automatically carry out a method comprising the steps (a) activating the timber bundle feed such that a timber bundle is positioned between the first pressure shoes and the second pressure shoes of the clamping slides, (b) activating the positioning drives such each positioning slide drives to its respective predetermined position, (c) activating the aligner such that the timber bundle is aligned along a plane, along which the timber bundle extends when it is lying on the timber bundle intake, in particular along an at least largely horizontal plan, and (d) activating the tensile force generator such that the positioning slides and the feed slides exert the predetermined press force on the timber bundle, resulting in the laminated timber beam. Preferably, the method comprises the step (e) activating the at least one transport roller drive such that the laminated timber beam is transported out of the laminated timber beam press, especially in the longitudinal direction.

The characteristic that the plane extends at least largely horizontally is understood particularly to mean that small deviations from the ideal horizontal course are possible. For example, a deviation of 10°, especially 5°, is tolerable.

It is beneficial if the control unit contains a digital memory in which the predetermined positions and/or a longitudinal contour of the laminated timber beam are stored. It is beneficial if the longitudinal contour of the laminated timber beam has at least one convex section and at least one concave section, particularly at least two convex sections and/or at least two concave sections.

Preferably, the control unit is configured to automatically (a) activate the timber beam production device such that timber slats are glued and combined to form a glued timber bundle, and (b) activate the timber bundle feed such that it places the timber bundle on the timber bundle intake between the first pressure shoes and the second pressure shoes. It is beneficial if the timber bundle production device is automatically activated in such a way that the timber slats are glued and/or arranged to form a timber bundle while another laminated timber beam is still being pressed.

It is beneficial if the laminated timber beams have a length of at least 30 m, especially at least 40 m. Alternatively or additionally, the laminated timber beams preferably have a height of at least 1 m, particularly at least 1.5 m, particularly preferably at least 2 m. A height of 2.5 m does not pose a problem for the system according to the invention; even greater heights are possible.

The timber bundle intake is preferably fixed to the positioning slide.

### DESCRIPTION OF THE DRAWINGS

In the following, the invention will be explained in more detail with the aid of the accompanying drawings. They show:

FIG. 1 a cross-section through a laminated timber beam production system according to the invention,

FIG. 2 in the partial FIGS. 2a, 2b, 2c, a schematic view from above of the laminated timber beam production system according to FIG. 1, wherein the partial figures depict the pressing of a laminated timber beam with different contours,

FIG. 3 a horizontal cross-section through a part of the laminated timber beam production system according to the invention,

FIG. 4 a cross-section through a clamping slide of a laminated timber beam production system according to the invention according to a second embodiment, and

FIG. 5 in the partial FIGS. 5a, 5b, 5c, 5d, the course of a method according to the invention.

### DETAILED DESCRIPTION

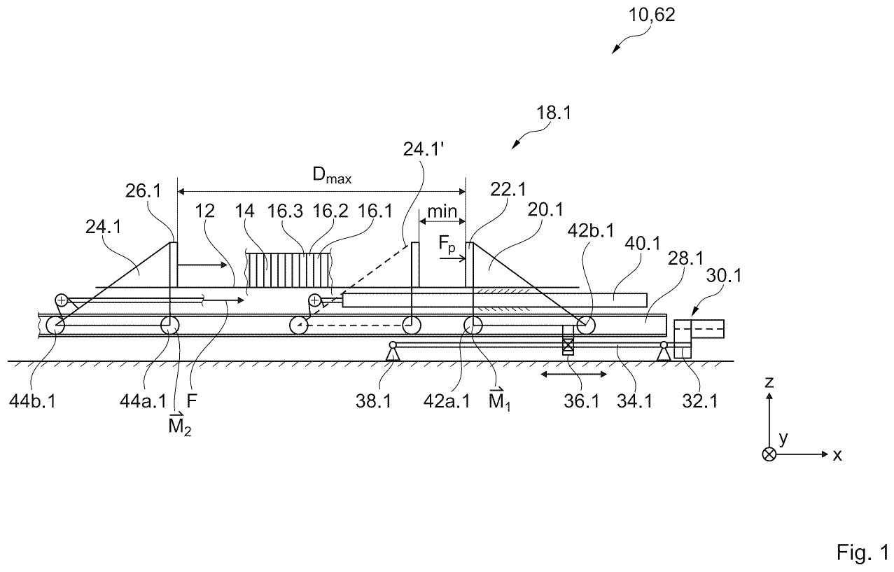

FIG. 1 depicts a laminated timber beam production system 10 according to the invention with a timber bundle intake 12 with glued timber slats 16.i (i=1,2,3, . . .) lying on it. The laminated timber beam production system 10 features a number of clamping slides 18.j, the first clamping slide 18.1 of which is depicted in the figure. The clamping slide 18.1 has a first positioning slide 20.1, which comprises a first pressure shoe 22.1, as well as a feed slide 24.1, which comprises a second pressure shoe 26.1. The delivery slide 24.1 is shown in two different positions: the first position is depicted by a solid line and the second position is depicted by a dashed line and bears the reference 24.1'. References without a numerical suffix refer to all corresponding objects.

The positioning slide 20.1 and the feed slide 24.1 can be moved in a line on a linear guide 28.1. The positioning slide 20.1 can be positioned in a predetermined position by means of a positioning drive 30.1. In the present case, this position is a position along an x axis.

The positioning drive 30.1 is preferably a screw drive comprising a motor 31.1, for example in the form of an electric motor, a threaded rod 34.1 and a nut 36.1 that moves on the threaded rod 34. The positioning drive 30.1 is fixed relative to the linear guide 28.1 in such a way that it can move the positioning slide with a maximum force of, for example, at least 10 kN, preferably at least 20 kN. A holding force is preferably at least 30 kN. The holding force is the force that can be exerted on the positioning drive during standstill without the positioning drive yielding. For example, a threaded rod 34 is mounted in an axial bearing 38.1 for this purpose.

The clamping slide 18.1 has a tensile force generator 40.1, for example in the form of a hydraulic pull cylinder, which is fixed to the positioning slide at one end and to the feed slide at the other. By actuating the tensile force generator 40.1, for example by subjecting the hydraulic pull cylinder 40.1 to a pressurised hydraulic fluid, the tensile force generator generates a tensile force Fₓ that pulls the feed slide 24.1 towards to positioning slide 20.1.

A maximum opening distance Dₘₐₓ in the form of the maximum adjustable distance between the first pressure shoe 42.1 and the second pressure shoe 26.1 is, for example, at least Dₘₐₓ=2.5 m, in particular at least Dₘₐₓ=3 m, for example at most Dₘₐₓ=4 m. The opening distance Dₘₐₓ is equal to the working space width B when the respective positioning slide 20.j and the respective feed slide 24.j, and thus the pressure shoes 22.j, 26.j, are in their basic position.

The clamping slide 18.1 comprises a guide part 42, which has two rollers 42a.1, 42b.1 in the present case that move in the linear guide 28.1 and absorb a tilting torque M₁ which occurs when the first pressure shoe 22.1 exerts the press force F_{P} on the timber bundle 14 due to the tensile force F_{Z}.

In the same way, the positioning slide 20.1 has a guide part 44, which in the present case has two rollers 44a.1, 44b.1 that move in the linear guide 28.1 and absorb a tilting torque M2 which occurs when the second pressure shoe 26.1 exerts the press force F_{P} on the timber bundle 14 due to the tensile force F_{Z}.

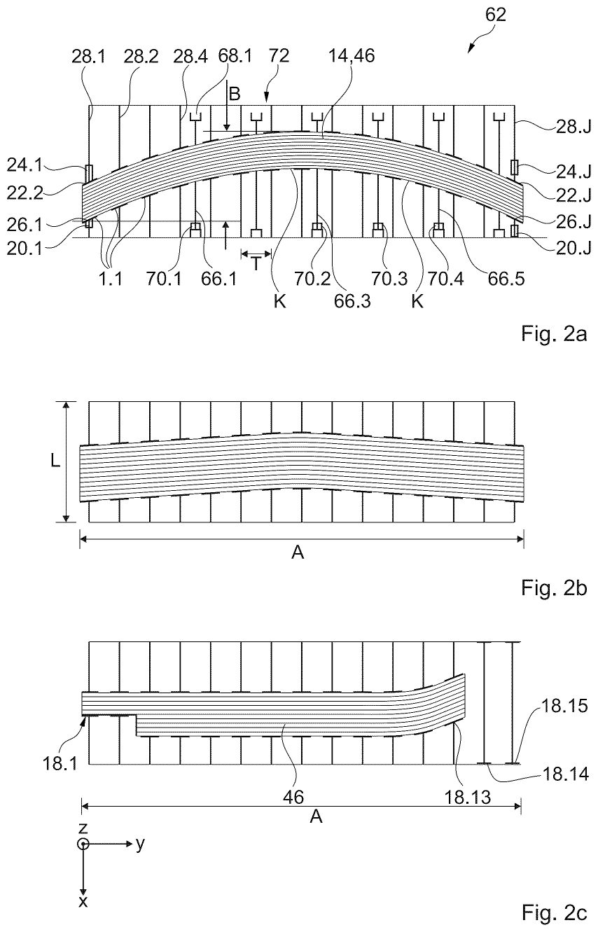

Partial FIG. 2a of FIG. 2 shows a view of the laminated timber beam production system 10 from above. It shows that the laminated timber beam production system 10 has a plurality of linear guides 28.j (j=1, 2, . . . , J) that extend parallel to each other and on each of which one feed slide 24.j and one positioning slide 20.j are guided. The timber bundle 14 is arranged between the respective first pressure shoe 22.j and the second pressure shoe 26.j, said bundle becoming a laminated timber beam 46 following pressing. A divide T, i.e. a distance between two adjacent linear guides 28.j, 28.j+1, is preferably between 600 mm and 1000 mm. The laminated timber beam 46 depicted in FIG. 2a has a constant radius of curvature.

The linear guides 28.j have a length L of, for example, L=6 m to L=10 m. A working space width B is the maximum distance along the linear guides 28.j between a largest possible x position x_{26,max} of a second pressure shoe 26.j and a smallest possible x position x_{22,min} of a first pressure shoe 22.j. Preferably, the working space width is at least B=2 m, especially at least 2.5 m and/or at most 4 m.

The laminated timber beam 46 follows a contour K. The positioning slides 20.j are positioned in such a way that the finished laminated timber beam 46 has the predetermined contour K.

FIG. 2b depicts a second contour for a laminated timber beam 46 in the form of a double pitch beam, which is curved at its centre and extends in a straight line at its side flanks.

FIG. 2c illustrates the laminated timber beam production system 10 according to the invention with a laminated timber beam 46 that has a step on the left and is curved at the right.

The timber bundle intake 12 (see FIG. 1), the clamping slides 18.j, the linear guides 28.j, the positioning drives 30.j and the tensile force generators 40.j constitute part of a laminated timber beam press 62. It should be noted that the laminated timber beam press 62 does not have to be occupied across its entire working space length A. Any clamping slides that are not required for pressing-clamping slides 18.14, 18.15 in FIG. 2c-c an remain unused, for example, at the maximum opening distance Dₘₐₓ.

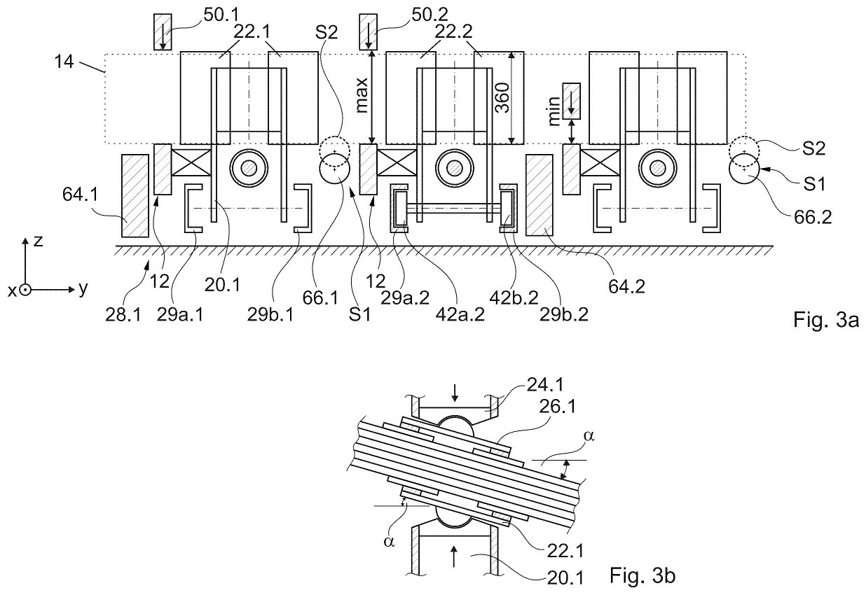

Partial FIG. 3a of FIG. 3 shows a horizontal cross-section through part of the laminated timber beam production system 10, currently showing that the linear guides 28.j each comprise two guide rails 29a.j , 29a.j in which the rollers 42a.j , 42b.j move.

Partial FIG. 3b illustrates that the first pressure shoes 22.j and the second pressure shoes 26.j can be fixed on the positioning slide 20.k or the feed slide 24.j such that they can be swivelled about a horizontal axis at a swivel axis a. A minimum swivel angle is preferably at least 5°, particularly at least 15°. For the purpose of adjustment to a curvature of the contour, the pressure shoe is preferably divided into at least two swivelling partial pressure shoes. The pressure force F is introduced into the beam as evenly as possible as a result.

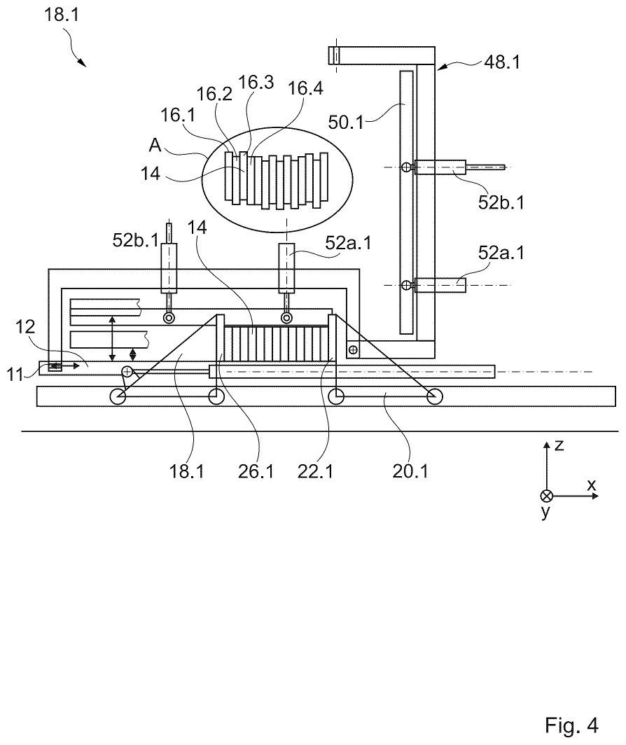

Figure shows a side view of part of a laminated timber beam production system 10 according to the invention with an aligner 48.1. The aligner 48.1 has a pressure beam 50.1, which can be pressed onto the timber bundle 14 by two drives 52a.1, 52b.1 such that the timber slats 16.1 can be moved from an unaligned arrangement, depicted in section A, into an aligned position. In the embodiments depicted in FIG. 4, the aligner 48 is pivotably mounted and can be brought into a clamping position, depicted by solid lines, and into a neutral position, in which the timber bundle 14 can be brought to between the first pressure shoe 42.1 and the second pressure shoe 22.2 from above.

It is beneficial, but not essential, for each clamping slide 18.j, in particular each positioning slide 20.j, to have an aligner. However, it is also possible that an aligner is fixed to only some of the clamping slides 18.j, in particular some of the positioning slides 20.j.

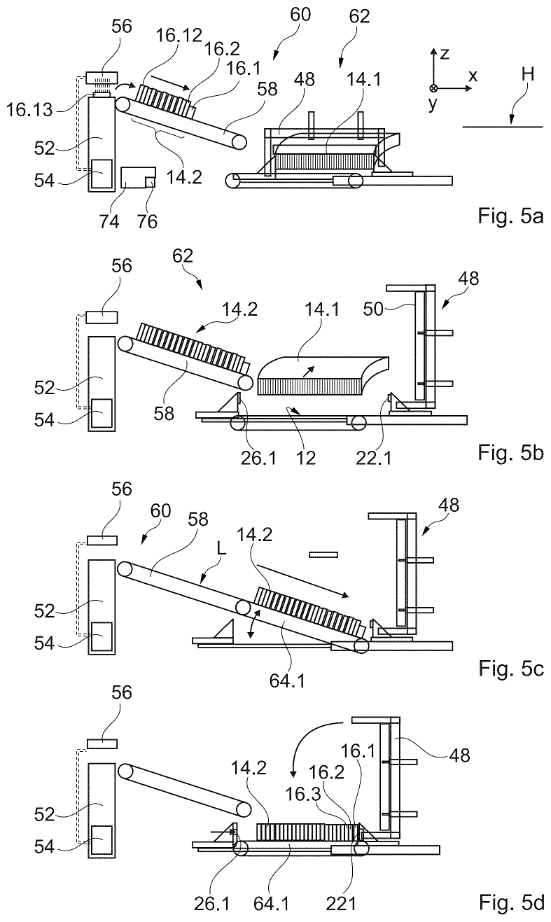

FIG. 5a shows a cross-section through a laminated timber beam production system 10 according to the invention that comprises a gluer 52 for glueing the timber slats 16.i, wherein the timber slat 16.13 is depicted. The gluer 52 has a glue container 54, which is connected to a glueing head 56. The glue container 54 contains glue with an open time T_{A} is preferably, but not necessarily, shorter than 30 minutes, for example T_{A}=15 minutes. The open time T_{A} is the maximum time that can pass from starting to apply the glue to the timber slats to closing the press.

After passing through the gluer 52, the glued timber slats 16.i are combined on the conveyor 58, in particular a chain conveyor, of the timber bundle feed 60 to form a timber bundle 14.2. This is preferably done while a timber bundle 14.1 is still being pressed in the laminated timber beam press 62.

FIG. 5b shows the state in which the finished laminated timber beam 14.1 is transported out of the laminated timber beam press 62. The clamping slides 18.j are then preferably driven along a line into their neutral position.

FIG. 5c shows the state in which the timber bundle 14.2 is transferred from the timber bundle feed 60, in particular by its conveyor 58, to a transfer conveyor 64.1. For this purpose, the transfer conveyor 64.1 is designed in such a way that, as depicted in FIG. 5c, it can be brought into a position, especially in a swivelling manner, in which it forms a continuous, especially flat, conveyor path F with the conveyor 58. The timber bundle 14.2 is positioned by the timber bundle feed 60 from above onto the timber bundle intake 12 between the first pressure shoe 22.1 and the second pressure shoe 26.1. Here, the aligner 48 is in its neutral position.

FIG. 5 d shows the state in which the transfer conveyor 64.1 is in its neutral position. The timber bundle 14.2 is then deposited on the timber bundle intake 12 between the first pressure shoes 22.j (22.1 is depicted) and the second pressure shoes 26.

The aligner 48 then swivels out of its depicted neutral position into the clamping position shown in FIG. 5 a, so that the timber slats 16.i are aligned.

FIG. 3a demonstrates that the laminated timber beam production system comprises multiple rollers 66.k (k=1, 2, . . . K), the height of which can be altered by means of a lift drive 68.k. In an inactive position S1 depicted in FIG. 3a, the rollers 66.k do not exert any force on a timber bundle located on the timber bundle intake 12. In an active position S2, the rollers 66.k are in contact with the timber bundle on the timber bundle intake 12, thereby enabling it to be transported out of the laminated timber beam press 62. To this end, the rollers are driven by means of a roller drive 70.k (compare FIG. 2 a) so that they can rotate about their longitudinal axis. The rollers 66.k, the lift drives 68.k and the roller drives 70.k form a roller bed 72. It is possible, but not necessary, for each roller to be driven by one roller drive.

The laminated timber beam production system 10 comprises a control unit 74 that is connected to remaining controllable components of the laminated timber beam production system 10. The control unit 74 is configured to automatically carry out a method comprising the steps (a) activating the transfer conveyor 64 and/or the timber bundle feed 60 such that the timber bundle 14 is positioned between the first pressure shoes 22.j and the second pressure shoes 26.j of the clamping slides 18.j, (b) activating the positioning drives 30.j such that the positioning slides 20.j each move to a predetermined position P_{20.}j which, for example, are stored in a digital memory 76 of the control unit 74, (c) activating the aligners 48.j such that the timber bundle 14 is aligned along a horizontal plane H (compare FIG. 5a), (d) activating the tensile force generator 40.j such that the positioning slides 20.j and the feed slides 24.j exert the predetermined press force Fₚ on the timber bundle 14, resulting in the laminated timber beam 46, and (e) activating the roller bed 72 such that the pressed laminated timber beam 46 is moved out of the laminated timber beam press 62.

Steps (b) and (c) are preferably conducted at least partially simultaneously.

The control unit 74 is preferably configured to automatically monitor the press time and the hydraulic press pressure and/or to open the alignment unit 48 and raise the pressure shoes 24.j and 26.j before activating the roller bed 72′.

### Reference List

10 laminated timber beam production system
12 timber bundle intake
14 timber bundle
16 timber slats
18 clamping slides
20 positioning slide
22 first pressure shoe
24 feed slide
26 second pressure shoe
28 linear guide
30 positioning drive
32 motor
34 screw drive
36 nut
38 axial bearing
40 tensile force generator
42 guide part
42a roller
44 guide part
44a roller
46 laminated timber beam
48 aligner
50 pressure beam
52 gluer
54 glue container
56 glueing head
58 conveyor
60 timber bundle feed
62 laminated timber beam press
64 transfer conveyor
66 roller
68 lift drive
70 roller drive
72 roller bed
74 control unit
76 digital memory
a swivel angle
A working space length
B working space height
Dₘₐₓ opening distance
F conveyor path
F_{P} press force
Fₓ tensile force
H horizontal plane
i running index (slats)
j running index (clamping slides)
k running index (rollers)
K contour
L length
M tilting torque
T divide

1. A laminated timber beam production system for producing curved laminated timber beams, comprising:
(a) a laminated beam intake for receiving a timber bundle composed of glued timber slats, and
(b) a plurality of clamping slides, each clamping slide of the plurality of clamping slides comprising
(i) one or more positioning slides, each of which comprises at least one first pressure shoe which is guidable on a linear guide,
(ii) one or more feed slides, each of which comprises at least one second pressure shoe which is guidable on the linear guide,
(iii) wherein at least one positioning slide of the one or more positioning slides and at least one feed slide of the one or more feed slides are arranged such that by moving the at least one positioning slide and the at least one feed slide towards each other, a predetermined press force is applyable to the timber bundle,
(c) wherein each of the one or more positioning slides is connected or connectable to a positioning drive for positioning the one or more positioning slides in a predeterminable position along the linear guide,
(d) wherein the plurality of the clamping slides comprise at least one tensile force generator,
(i) wherein the at least one tensile force generator is configured to automatically generate a tensile force that acts in each case between a positioning slide of the of the one or more positioning slides and a feed slide of the one or more feed slides, and
(ii) wherein at least one tensile force generator is arranged below a contact surface of the timber bundle intake.

2. The laminated timber beam production system according to claim 1,
(a) wherein the plurality of clamping slides are open at a top such that the timber bundle is positionable from above between one or more positioning slides and the one or more feed slides by moving the timber bundle,
(b) wherein the plurality of clamping slides comprise at least one guide part by way of which the at least one clamping slide of the plurality of clamping slides is movably fixed to the linear guide,
(c) wherein the at least one tensile force generator comprises a hydraulic cylinder and is configured to automatically generate a tensile force of at least 250 kilonewton, and
(d) wherein the linear guide is designed to absorb a tilting torque that develops due to the generated tensile force on the guide part.

3. The laminated timber beam production system according to claim 1
(a) wherein the laminated timber beam production system is designed to produce curved laminated timber beams,
(b) wherein the plurality of clamping slides are arranged in relation to the timber bundle intake such that the timber bundle is clampable along a curve,
(c) wherein the one or more feed slides are designed such that at least a portion of the press force acts along a plane along which the timber bundle extends when the timber bundler is lying on the timber bundle intake, and
(d) wherein the plurality of clamping slides are designed to jointly clamp the timber bundle.

4. The laminated timber beam production system according to claim 1 further comprising a plurality of aligners, each of which comprises
(a) a pressure beam, and
(b) a pressure beam drive by which the pressure beam is pressable from above onto the timber bundle.

5. The laminated timber beam production system according to claim 3, further comprising a plurality of aligners fixed in each case to one clamping slide of the plurality of clamping slides, and wherein the
(a) aligners are bringable into a clamping position for pressing onto the timber bundle by a pressure beam, and
(b) aligners are bringable into a neutral position in which the timber bundle is receivable by a clamping slide of the plurality of clamping slides.

6. The laminated timber beam production system according to claim 1 wherein the positioning drive comprises a threaded spindle and/or is self-locking.

7. The laminated timber beam production system according to claim 1 further comprising:
(a) a timber bundle feed designed to automatically feed the timber bundle between the at least one first pressure shoe and the at least one second pressure shoe, and (b) a timber bundle production device for producing the timber bundle made up of timber slats comprising a gluer designed to glue the timber slats.

8. The laminated timber beam production system according to claim 7, wherein
(a) the timber bundle feed is designed to automatically feed the timber bundle from above, and/or
(b) the laminated timber beam production system comprises a transfer conveyor which
(i) is bringable into a transfer position in which, together with a conveyor of the timber bundle feed forms a conveyor path for the timber bundle, and
(ii) is bringable into a neutral position in which the timber bundle is arranged in the at least one clamping slide of the plurality of clamping slides for pressing.

9. The laminated timber beam production system according to claim 1 further comprising a roller bed which
(a) comprises a plurality of height-adjustable mounted transport rollers, and
(b) comprises at least one transport roller drive for driving the plurality of height-adjustable transport rollers, and
(c) wherein the roller bed is designed to transport laminated timber beams out of the laminated timber beam production system.

10. The laminated timber beam production system according to claim 1 further comprising a control unit programmed or configured to automatically carry out a method comprising
(a) activating a transfer conveyor such that a timber bundle is positioned between the at least one first pressure shoe and the at least one second pressure shoe of a clamping slide of the plurality of clamping slides,
(b) activating a positioning drive so that the one or more positioning slides are driven to a predetermined position,
(c) activating one or more aligners such that the timber bundle is aligned along a plane along which the timber bundle extends when it is lying on the timber bundle intake,
(d) activating the at least one tensile force generator such that the one or more positioning slides and the one or more feed slides exert the predetermined press force on the timber bundle resulting in a laminated timber beam, and
(e) activating a roller bed such that the laminated timber beam is transported out of the laminated timber beam production system.

11. The laminated timber beam production system according to claim 1, further comprising features configured to automatically
(a) glue timber slats by a gluer, and
(b) arrange glued timber slats next to each other, resulting in a timber bundle,
(c) wherein the timber slats are at least at times being glued while another laminated timber beam is being pressed.

12. A method for producing a laminated timber beam by means of a laminated timber beam production system according to claim 1, comprising:
(a) activating a transfer conveyor and/or a timber bundle feed such that a timber bundle is positioned between the at least one first press shoe and the at least one second press shoe of a clamping slide of the plurality of clamping slides,
(b) activating the positioning drive so that the one or more positioning slides drive to a predetermined position,
(c) activating one or more aligners such that the timber bundle is aligned along a horizontal plane,
(d) activating the at least one tensile force generator such that the one or more positioning slides and the one or more feed slides exert the predetermined press force on the timber bundle resulting in a produced laminated timber beam, and
(e) activating a roller bed such that the produced laminated timber beam is transported out of the laminated timber beam production system.

13. A laminated timber beam production system for producing curved laminated timber beams, comprising:
(a) a laminated beam intake for receiving a timber bundle composed of glued timber slats, and
(b) a plurality of clamping slides, each clamping slide of the plurality of clamping slides comprising
(i) one or more positioning slides, each of which comprises at least one first pressure shoe which is guidable on a linear guide,
(ii) one or more feed slides, each of which comprises at least one second pressure shoe which is guidable on the linear guide,
(iii) wherein at least one positioning slide of the one or more positioning slides and at least one feed slide of the one or more feed slides are arranged such that by moving the at least one positioning slide and the at least one feed slide towards each other, a predetermined press force is applyable to the timber bundle,
(c) wherein each of the one or more positioning slides is connected or connectable to a positioning drive for positioning the one or more positioning slides in a predeterminable position along the linear guide,
(d) wherein the plurality of the clamping slides comprise at least one tensile force generator,
wherein the at least one tensile force generator is configured to automatically generate a tensile force that acts in each case between a positioning slide of the of the one or more positioning slides and a feed slide of the one or more feed slides, and
(e) wherein the laminated beam intake extends at least predominantly horizontally.

14. The laminated timber beam production system according to claim 13 wherein the positioning drive comprises a threaded spindle and/or is self-locking.

15. The laminated timber beam production system according to claim 13 further comprising a roller bed which
(d) comprises a plurality of height-adjustable mounted transport rollers, and
(e) comprises at least one transport roller drive for driving the plurality of height-adjustable transport rollers, and
(f) wherein the roller bed is designed to transport laminated timber beams out of the laminated timber beam production system.

16. The laminated timber beam production system according to claim 1 further comprising:
a timber bundle feed designed to automatically feed the timber bundle between the at least one first pressure shoe and the at least one second pressure shoe;
a timber bundle production device for producing the timber bundle made up of timber slats comprising a gluer designed to glue the timber slats; and
a transfer conveyor which
(i) is bringable into a transfer position in which, together with a conveyor of the timber bundle feed forms a conveyor path for the timber bundle, and
(ii) is bringable into a neutral position in which the timber bundle is arranged in the at least one clamping slide of
the plurality of clamping slides for pressing.
